(19) United States
(12) Patent Application Publication
(10) Pub. No.: US 2017/0283669 A1
(43) Pub. Date: Oct. 5, 2017

(54) PRESSURE-SENSITIVE ADHESIVE CONTAINING NANOCRYSTALLINE CELLULOSE

(71) Applicant: 3M INNOVATIVE PROPERTIES COMPANY, St. Paul, MN (US)

(72) Inventors: Corinne E. Lipscomb, St. Paul, MN (US); Kevin M. Lewandowski, Inver Grove Heights, MN (US); Carla S. Thomas, Woodbury, MN (US); Jayshree Seth, Woodbury, MN (US); Lili Qie, Woodbury, MN (US)

(21) Appl. No.: 15/507,369

(22) PCT Filed: Aug. 31, 2015
(86) PCT No.: PCT/US2015/047643

§ 371 Date: Feb. 28, 2017

Related U.S. Application Data
(60) Provisional application No. 62/045,823, filed on Sep. 4, 2014.

(51) Int. Cl. C09J 133/08; C08L 1/02; C08F 220/18; C09J 7/04

(52) U.S. Cl. CPC C09J 133/08; C09J 7/045; C08L 1/02; C08F 220/18; C09J 2201/606

(57) ABSTRACT

A pressure-sensitive adhesive is provided including an emulsion polymer containing a (meth)acrylate copolymer and nanocrystalline cellulose. The inclusion of the nanocrystalline cellulose results in an increase in the overlap shear properties of the adhesive while maintaining the peel adhesion. Articles and emulsions including the pressure-sensitive adhesive are also provided.

### FIELD

The present disclosure relates to pressure-sensitive adhesives.

### BACKGROUND

Pressure-sensitive adhesives (PSAs) are known to possess properties including the following: (1) aggressive and permanent tack, (2) adherence with no more than finger pressure, (3) sufficient ability to hold onto an adherend, and (4) sufficient cohesive strength to be removed cleanly from the adherend. Materials that have been found to function well as PSAs include polymers designed and formulated to exhibit the requisite viscoelastic properties resulting in a desired balance of tack, peel adhesion, and shear holding power. PSAs are characterized by being normally tacky at room temperature (e.g., 20° C.). PSAs do not embrace compositions merely because they are sticky or adhere to a surface.

U.S. Pat. No. Re. 24,906 (Ulrich) discloses a pressure-sensitive adhesive tape, the adhesive layer of which comprises a copolymer of acrylic acid ester and a copolymerizable monomer such as acrylic acid, described therein as an “acrylic pressure-sensitive adhesive tape”. Although acrylic pressure-sensitive adhesive tape may provide high shear strength and good adhesion, there has been a need for even higher shear strength, especially at elevated temperatures, without any reduction in adhesion, particularly in peel strength.

### SUMMARY

Pressure-sensitive adhesives containing nanocrystalline cellulose including articles and emulsions are provided. In a first aspect, a pressure-sensitive adhesive is provided. More particularly, a pressure-sensitive adhesive is provided including (a) a polymer comprising (i) 80 to 97 parts by weight of monomer units of an (meth)acrylic acid ester of non-tertiary alcohol, the alcohol having from 1 to 20 carbon atoms; (ii) 0 to 10 parts by weight of monomer units of an acid functional monomer; (iii) 0 to 20 parts by weight of monomer units of a second polar monomer; (iv) 0 to 5 parts by weight vinyl monomer units; and (v) 0 to 1 parts by weight crosslinking agent. The pressure-sensitive adhesive further includes (b) 0.5 to 15 parts by weight of nanocrystalline cellulose.

In a second aspect, an article is provided. The article includes (a) a substrate; and (b) a first layer of the pressure-sensitive adhesive according to the first aspect positioned adjacent to a first surface of the substrate.

In a third aspect, an emulsion is provided. The emulsion includes (a) 30 to about 70 weight percent, based on the total weight of the emulsion, of a polymer phase comprising the reaction product of (i) 80 to 95 parts by weight of an (meth)acrylic acid ester of non-tertiary alcohol, the alcohol having from 1 to 20 carbon atoms, with the average number of carbon atoms being from about 4 to about 12; (ii) 0 to 10 parts by weight of an acid functional monomer; (iii) 0 to 20 parts by weight of a second, non-acid functional, polar monomer; (iv) 0 to 5 parts by weight of vinyl monomer; (v) optionally 0.01 to 1 parts by weight of a crosslinking agent; (vi) 0 to 0.5 parts by weight of a chain transfer agent; and (vii) 0.5 to 15 parts by weight of nanocrystalline cellulose, based on 100 parts of polymer, wherein the sum of (i) through (vii) is 100 parts by weight. The emulsion further includes (b) 30 to 70 weight percent of an aqueous phase comprising a surfactant, based on the total weight of the emulsion.

The inclusion of the nanocrystalline cellulose results in an increase in the overlap shear properties of the adhesive while maintaining the peel adhesion.

### DETAILED DESCRIPTION

Pressure-sensitive adhesives, including articles and emulsions are provided. The addition of nanocrystalline cellulose results in a significant increase in the overlap shear properties of the adhesive while maintaining the peel adhesion. Advantageously, only a small amount of nanocrystalline cellulose (0.5-15 weight percent, relative to the weight of the adhesive (meth)acrylate copolymer) are needed to observe the increase in shear properties with the acrylic pressure-sensitive adhesives described herein. In another aspect, the present invention provides an aqueous emulsion comprising a (meth)acrylate copolymer and nanocrystalline cellulose, which may be coated and dried to yield a pressure-sensitive adhesive.

For environmental reasons, there is a desire to move away from the use of volatile organic solvents (VOC's) in coating processes, and towards more environmentally friendly water-based materials, so the present invention provides a waterborne adhesive comprising an emulsion (meth)acrylate copolymer and nanocrystalline cellulose. Waterborne systems are desirable for cost, environmental, safety, and regulatory reasons. The aqueous system may be readily coated, and provides a pressure-sensitive adhesive when dried.

The recitation of any numerical range by endpoints is meant to include the endpoints of the range, all numbers within the range, and any narrower range within the stated range (e.g. 1 to 5 includes 1, 1.5, 2, 2.75, 3, 3.8, 4, and 5). Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

For the following Glossary of defined terms, these definitions shall be applied for the entire application, unless a different definition is provided in the claims or elsewhere in the specification.

### Glossary

Certain terms are used throughout the description and the claims that, while for the most part are well known, may require some explanation. It should be understood that, as used herein:

The term “a”, “an”, and “the” are used interchangeably with “at least one” to mean one or more of the elements being described.

The term “and/or” means either or both. For example, the expression “A and/or B” means A, B, or a combination of A and B.

The term “emulsion” refers to a stable mixture of two or more immiscible liquids held in suspension by one or more surfactants, more specifically it refers to a stable mixture of the instant polymerizable monomer mixture, or resultant polymer, and water.

The term “latex” refers to an aqueous suspension or emulsion of a polymer, more specifically it refers to an aqueous emulsion of the instant polymer.

The term “oil-in-water emulsion” refers to a mixture in which the water forms a continuous phase and the monomers (oil) are in discontinuous droplets.

The term “oil phase” in an oil-in-water emulsion refers to all components in the formulation that individually exceed their solubility limit in the water phase; these are materials that generally have solubilities of less than 1% in distilled water, however, water phase components such as salts may decrease the solubility of certain oils resulting in their partitioning into the oil phase.

The term “water phase” in an oil-in-water emulsion refers to the water present and any components that are water soluble, i.e., have not exceeded their solubility limit in water.

The term “(meth)acrylate monomers” refers to acrylic acid esters or methacrylic acid esters of alcohols.

The term “hydrophobic” is used herein to mean that the monomer lacks substantial affinity for water, that is, it neither substantially adsorbs nor absorbs water at room temperature.

The term “hydrophilic” is used herein to mean that the monomer has a substantial affinity for water.

In a first aspect, a pressure-sensitive adhesive is provided, comprising:

(a) a polymer comprising:
(i) 80 to 97 parts by weight of monomer units of an (meth)acrylic acid ester of non-tertiary alcohol, the alcohol having from 1 to 20 carbon atoms;
(ii) 0 to 10 parts by weight of monomer units of an acid functional monomer;
(iii) 0 to 20 parts by weight of monomer units of a second polar monomer;
(iv) 0 to 5 parts by weight vinyl monomer units; and
(v) 0 to 1 parts by weight crosslinking agent; and
(b) 0.5 to 15 parts by weight of nanocrystalline cellulose.

In a second aspect, an article is provided, comprising:
(a) a substrate; and
(b) a first layer of the pressure-sensitive adhesive according to the first aspect positioned adjacent to a first surface of the substrate.

In a third aspect, an emulsion is provided, comprising:

(a) 30 to about 70 weight percent, based on the total weight of the emulsion, of a polymer phase comprising the reaction product of:
(i) 80 to 95 parts by weight of an (meth)acrylic acid ester of non-tertiary alcohol, the alcohol having from 1 to 20 carbon atoms, with the average number of carbon atoms being from about 4 to about 12;
(ii) 0 to 10 parts by weight of an acid functional monomer;
(iii) 0 to 20 parts by weight of a second, non-acid functional, polar monomer;
(iv) 0 to 5 parts by weight of vinyl monomer;
(v) optionally 0.01 to 1 parts by weight of a crosslinking agent,
(vi) 0 to 0.5 parts by weight of a chain transfer agent
(vii) 0.5 to 15 parts by weight of nanocrystalline cellulose, based on 100 parts of polymer, wherein the sum of (i) through (vii) is 100 parts by weight, and

(b) 30 to 70 weight percent of an aqueous phase comprising a surfactant, based on the total weight of the emulsion.

Preferably the emulsion comprises about 50 to about 65 percent by weight polymer and about 35 to about 50 percent by weight aqueous phase, most preferably about 55 to about 62 percent by weight solid phase and about 38 to about 45 percent by weight aqueous phase, based upon the total weight of the emulsion, in order to minimize the aqueous phase and thus conserve energy during the drying of the latex, in order to minimize storage and shipping costs, and in order to maximize plant productivity. The emulsion may be coated and dried to produce a pressure-sensitive adhesive. The polymer component of the adhesive composition may comprise one or more polymers.

The acrylate ester monomer useful in preparing the adhesive polymer is a hydrophobic monomeric (meth)acrylic ester of a non-tertiary alcohol, which alcohol contains from 1 to 20 carbon atoms, such as an average of from 4 to 12 carbon atoms.

Examples of monomers suitable for use as the acrylate ester monomer include the esters of either acrylic acid or methacrylic acid with non-tertiary alcohols such as ethanol, 1-propanol, 2-propanol, 1-butanol, 2-butanol, 1-pentanol, 2-pentanol, 3-pentanol, 2-methyl-1-butanol, 1-hexanol, 2-hexanol, 2-methyl-1-pentanol, 3-methyl-1-pentanol, 2-ethyl-1-butanol, 3,5,5-trimethyl-1-hexanol, 3-heptanol, 1-octanol, 2-octanol, isooctylalcohol, 2-ethyl-1-hexanol, 1-decanol, 1-dodecanol, 1-tridecanol, 1-tetradecanol and the like. In some embodiments, the preferred acrylate ester monomer is the ester of acrylic acid with butyl alcohol or isooctyl alcohol, or a combination thereof, although combinations of two or more different acrylate ester monomers are suitable. In some embodiments, a preferred acrylate ester monomer is 2-octyl acrylate.

The acrylate ester monomer is typically present in an amount of 80 to 99 parts by weight based on 100 parts total monomer content used to prepare the polymer (i.e., the total of i through v in the composition supra). In certain embodiments, the acrylate ester monomer is present in an amount of 90 to 95 parts by weight based on 100 parts total monomer content used to prepare the polymer.

The polymer optionally further comprises an acid functional monomer, where the acid functional group may be an acid per se, such as a carboxylic acid, or a salt thereof such as an alkali metal carboxylate. Useful acid functional monomers include, but are not limited to, those selected from ethylenically unsaturated carboxylic acids, ethylenically unsaturated sulfonic acids, ethylenically unsaturated phosphonic acids, and mixtures thereof. Examples of such compounds include those selected from acrylic acid, methacrylic acid, itaconic acid, fumaric acid, crotonic acid, citraconic acid, maleic acid, oleic acid, β-carboxyethyl acrylate, 2-sulfoethyl methacrylate, styrene sulfonic acid, 2-acrylamido-2-methylpropanesulfonic acid, vinylphosphonic acid, and mixtures thereof.

Due to their availability, acid functional monomers of the present invention are generally selected from ethylenically unsaturated carboxylic acids, i.e., (meth)acrylic acids. When even stronger acids are desired, acidic monomers include the ethylenically unsaturated sulfonic acids and ethylenically unsaturated phosphonic acids. The acid functional monomer is generally used in amounts of 0 to 10 parts by weight, such as 0 to 5 parts by weight or 1 to 5 parts by weight, based on 100 parts by weight total monomer.

Polar monomers useful in preparing the adhesive polymer are both somewhat oil soluble and water soluble, resulting in a distribution of the polar monomer between the aqueous and oil phases in an emulsion polymerization. In addition to the acid functional monomers mentioned above, other useful polar monomers are non-acid functional. These polar monomers are generally used in amounts of 0 to 20 parts by weight, such as 0 to 15 parts by weight, 1 to 15 parts by weight, or 1 to 10 parts by weight, based on 100 parts by weight total monomer.

Representative examples of suitable non-acid functional polar monomers include but are not limited to 2-hydroxylethyl (meth)acrylate; N-vinylpyrrolidone; N-vinylcaprolactam; acrylamide; mono- or di-N-alkyl substituted acrylamide; t-butyl acrylamide; dimethylaminoethyl acrylamide; N-octyl acrylamide; poly(alkoxyalkyl) acrylates including 2-(2-ethoxyethoxy)ethyl acrylate, 2-ethoxyethyl acrylate, 2-methoxyethoxyethyl acrylate, 2-methoxyethyl methacrylate, polyethylene glycol mono(meth)acrylates; alkyl vinyl ethers, including vinyl methyl ether; and mixtures thereof. Preferred polar monomers include those selected from the group consisting of 2-hydroxyethyl (meth)acrylate and N-vinylpyrrolidinone.

When used, vinyl monomers useful in the acrylate adhesive polymer include vinyl esters (e.g., vinyl acetate and vinyl propionate), styrene, substituted styrene (e.g., α-methyl styrene), vinyl halide, and mixtures thereof. Such vinyl monomers are generally used at 0 to 5 parts by weight, such as 1 to 5 parts by weight, based on 100 parts by weight total monomer.

In order to increase cohesive strength of the coated adhesive composition, a crosslinking additive may be incorporated into the blend or polymerizable monomers. Crosslinking may also be achieved using high energy electromagnetic radiation such as gamma, UV or e-beam radiation.

Multi-functional acrylates are particularly useful for emulsion polymerization. Examples of useful multi-functional acrylate crosslinking agents include, but are not limited to, diacrylates, triacrylates, and tetraacrylates, such as 1,6-hexanediol diacrylate, poly(ethylene glycol) diacrylates, polybutadiene diacrylate, polyurethane diacrylates, and propoxylated glycerin triacrylate, and mixtures thereof.

Hydrolyzable, free-radically copolymerizable crosslinkers, such as monoethylenically unsaturated mono-, di-, and trialkoxy silane compounds including, but not limited to, methacryloxypropyltrimethoxysilane (available from Gelest, Inc., Tullytown, Pa.), vinyl dimethylethoxysilane, vinyl methyl diethoxysilane, vinyltriethoxysilane, vinyltrimethoxysilane, vinyltriphenoxysilane, and the like, are also useful crosslinking agents.

The amount and identity of crosslinker is tailored depending upon application of the adhesive composition. Typically, the crosslinker is present in amounts less than 5 parts based on total dry weight of adhesive composition. More specifically, the crosslinker is optionally present in amounts from 0.01 parts to 1 part based on 100 parts total monomers of the adhesive composition.

The composition further comprises nanocrystalline cellulose, which is a highly crystalline bio-based nanoparticle that is water dispersible due to the presence of alcohol and acid groups on the surface of the nanoparticle. Nanocrystalline cellulose is made from cellulose via a process in which the cellulose is treated with acid (e.g., sulfuric acid) to degrade its amorphous regions and leave the highly crystalline regions intact. Cellulose is the major structural component of plant cell walls, and is a linear polysaccharide polymer formed of β(1→4) linked D-glucose units, the chains of which arrange themselves to form crystalline and amorphous domains. The crystallinity of nanocrystalline cellulose is typically greater than 80%, greater than 85%, greater than 90%, or even greater than 95%. Nanocrystalline cellulose comprises crystallites having cross-sections ranging from 5 nanometers (nm) to 30 nm, and lengths ranging from 50 nm to 300 nm, such as from 100 nm to 300 nm. For instance, the cross-section is typically at least 5 nm, or at least 10 nm, or at least 15 nm, and up to 30 nm, or up to 25 nm, or up to 20 nm. The length is typically at least 50 nm, or at least 100 nm, or at least 150 nm, or at least 200 nm, and up to 300 nm, or up to 250 nm. The charged crystallites can be suspended in water, and when dried, nanocrystalline cellulose forms an agglomeration of particles. In most embodiments, the nanocrystalline cellulose is not surface modified. As used herein, “surface modified” refers to altering functional groups on the nanocrystalline cellulose, such as exchanging acid surface groups for other cations (e.g., alkaline earth cations, metal cations, etc.) or covalently functionalizing the nanocrystalline cellulose with molecules or polymers via chemical reaction, such as at alcohol groups on the nanocrystalline cellulose.

The nanocrystalline cellulose is typically present in adhesives of the present disclosure in an amount from 0.5 to 15 parts by weight, such as at least 0.5 parts by weight, or at least 1 part by weight, or at least 2 parts by weight, or at least 5 parts by weight, or at least 7 parts by weight, based on 100 parts of polymer. The nanocrystalline cellulose is typically present in an amount of up to 15 parts by weight, or up to 12 parts by weight, or up to 10 parts by weight, or up to 8 parts by weight, or up to 5 parts by weight, based on 100 parts of polymer. Suitable nanocrystalline cellulose is commercially available from the U.S. Forest Service Forest Products Laboratory (Madison, Wis.) via the University of Maine (Orono, Me.).

Other additives can be added in order to enhance the performance of the adhesive compositions. For example, leveling agents, ultraviolet light absorbers, hindered amine light stabilizers (HALS), oxygen inhibitors, rheology modifiers, wetting agents, defoamers, biocides, dyes and the like, can be included herein. All of these additives and the use thereof are well known in the art. It is understood that any of these compounds can be used so long as they do not deleteriously affect the adhesive properties.

The polymers herein can be prepared by any conventional free radical polymerization method, including solution, radiation, bulk, dispersion, emulsion, and suspension processes. The acrylate polymers may be prepared via suspension polymerizations as disclosed in U.S. Pat. No. 3,691,140 (Silver); U.S. Pat. No. 4,166,152 (Baker et al.); U.S. Pat. No. 4,636,432 (Shibano et al); U.S. Pat. No. 4,656,218 (Kinoshita); and U.S. Pat. No. 5,045,569 (Delgado). Each describes adhesive compositions, and the descriptions of polymerization processes are incorporated herein by reference. The acrylate polymer is typically prepared by an emulsion polymerization process in the presence of a free-radical initiator.

Water-soluble and oil-soluble initiators useful in preparing the acrylate adhesive polymers used in the present invention are initiators that, on exposure to heat, generate free-radicals which initiate (co)polymerization of the monomer mixture. Water-soluble initiators are often employed for preparing the acrylate polymers by emulsion polymerization. Suitable water-soluble initiators include but are not limited to those selected from the group consisting of potassium persulfate, ammonium persulfate, sodium persulfate, and mixtures thereof; oxidation-reduction initiators such as the reaction product of the above-mentioned persulfates and reducing agents such as those selected from the group consisting of sodium metabisulfite and sodium bisulfite; and 4,4′-azobis(4-cyanopentanoic acid) and its soluble salts (e.g., sodium, potassium). The preferred water-soluble initiator is potassium persulfate. Suitable oil-soluble initiators include but are not limited to those selected from the group consisting of azo compounds such as VAZO 64 (2,2′-azobis(isobutyronitrile)) and VAZO 52 (2,2′-azobis(2,4-dimethylpentanenitrile)), both available from E.I. du Pont de Nemours Co., peroxides such as benzoyl peroxide and lauroyl peroxide, and mixtures thereof. A suitable oil-soluble thermal initiator is (2,2′-azobis(isobutyronitrile)). When used, initiators may comprise from about 0.05 to about 1 part by weight, such as about 0.1 to about 0.5 part by weight based on 100 parts by weight of monomer components in the pressure-sensitive adhesive.

The copolymerizable emulsion mixture may optionally further comprise chain transfer agents to control the molecular weight of the resultant polymer. Examples of useful chain transfer agents include but are not limited to those selected from the group consisting of carbon tetrabromide, alcohols, mercaptans, and mixtures thereof. When present, the chain transfer agents are often isooctylthioglycolate and carbon tetrabromide. The emulsion mixture may further comprise up to about 0.5 parts by weight of a chain transfer agent, typically about 0.01 to about 0.5 parts by weight, if used, preferably about 0.05 parts by weight to about 0.2 parts by weight, based upon 100 parts by weight of the total monomer mixture.

Polymerization via emulsion techniques may require the presence of an emulsifier (which may also be called an emulsifying agent or a surfactant). Useful emulsifiers for the present invention include those selected from the group consisting of anionic surfactants, cationic surfactants, nonionic surfactants, and mixtures thereof.

Useful anionic surfactants include but are not limited to those whose molecular structure includes at least one hydrophobic moiety selected from the group consisting of from about C₆- to C₁₂-alkyl, alkylaryl, and/or alkenyl groups as well as at least one anionic group selected from the group consisting of sulfate, sulfonate, phosphate, polyoxyethylene sulfate, polyoxyethylene sulfonate, polyoxyethylene phosphate, and the like, and the salts of such anionic groups, wherein said salts are selected from the group consisting of alkali metal salts, ammonium salts, tertiary amino salts, and the like. Representative commercial examples of useful anionic surfactants include sodium lauryl sulfate, available from Stepan Chemical Co. as POLYSTEP B-3; sodium lauryl ether sulfate, available from Stepan Chemical Co. as POLYSTEP B-12; and sodium dodecyl benzene sulfonate, available from Rhone-Poulenc as SIPONATE DS-10.

Useful nonionic surfactants include but are not limited to those whose molecular structure comprises a condensation product of an organic aliphatic or alkyl aromatic hydrophobic moiety with a hydrophilic alkylene oxide such as ethylene oxide. The HLB (Hydrophilic-Lipophilic Balance) of useful nonionic surfactants is about 10 or greater, preferably from about 10 to about 20. The HLB of a surfactant is an expression of the balance of the size and strength of the hydrophilic (water-loving or polar) groups and the lipophilic (oil-loving or non-polar) groups of the surfactant. Commercial examples of nonionic surfactants useful in the present invention include but are not limited to nonylphenoxy or octylphenoxy poly(ethyleneoxy)ethanols available from Rhone-Poulenc as the IGEPAL CA or CO series, respectively; C₁₁-C₁₅ secondary-alcohol ethoxylates available from Dow Chemical Company as the TERGITOL 15-S series; and polyoxyethylene sorbitan fatty acid esters available from ICI Chemicals as the TWEEN series of surfactants.

Useful cationic surfactants include alkylammonium salts having the formula: CₙH₂ₙ₊₁N⁺(CH₃)³ X⁻, where X is OH, Cl, Br, HSO₄, or a combination thereof, and where n is an integer from 8 to 22; and the formula: CₙH₂ₙ₊₁N⁺(C₂H₅)₃ X⁻, where n is an integer from 12 to 18; gemini surfactants, for example those having the formula: [C₁₆H₃₃N⁺(CH₃)₂CₘH₂ₘ₊₁] X⁻, wherein m is an integer from 2 to 12 and X is as defined above; aralkylammonium salts such as, for example, benzalkonium salts; and cetylethylpiperidinium salts, for example, having the formula: C₁₆H₃₃N⁺(C₂H₅)(C₅H₁₀) X⁻, wherein X is as defined above.

Alternatively, the surfactant may be an ionic surfactant copolymerizable with the monomer mixtures, and is incorporated into the polymer chain during polymerization. Examples of useful copolymerizable ionic surfactants include but are not limited to those described in WO 89/12618 (Tang et al.). The surfactants described therein have a hydrophobic portion containing alpha-beta ethylenic unsaturation, a hydrophilic portion containing a poly(alkyleneoxy) segment, and an ionic segment.

According to WO 89/12618, the reactive surfactants arise from successive condensation polymerizations of an ethylenically-unsaturated alcohol with a prescribed amount of a first cyclic ether, e.g., propylene oxide, butylene oxide or a mixture thereof, followed by condensation with a prescribed amount of ethylene oxide. Cationic or anionic end-group functionality is added via the terminal hydroxyl group, as desired.

The ionic copolymerizable surfactant has at least one group, preferably one group, capable of reacting with the copolymerizable monomer mixture. Such reactive groups include but are not limited to those groups selected from the group consisting of ethylenically unsaturated groups such as vinyl groups, acrylate groups, etc.

A suitable copolymerizable surfactant, which has the trade name MAZON SAM-211, is available from PPG Industries, Inc. and is described as an alkylene polyalkoxy ammonium sulfate, wherein the number of alkoxy groups is between about 5 and about 25, with a typical example having about 15 to about 20 ethoxy groups. Examples of additional useful copolymerizable surfactants include alkyl allyl sulfosuccinates such as TREM-LF40, available from Diamond Shamrock Company. Additional useful copolymerizable surfactants are disclosed in U.S. Pat. Nos. 3,925,442 and 3,983,166, assigned to The Kendall Company, both incorporated by reference herein.

It is also envisioned that the emulsion of the present invention can be made using a mixture of a copolymerizable surfactant as delineated above and a typical ionic or nonionic noncopolymerizable surfactant commonly known in the art of emulsion polymerization, in place of the ionic copolymerizable surfactant above. Example of such non-copolymerizable surfactants can be found in “Emulsion Polymerization: theory and practice”, by D. C. Blackley, New York, J. Wiley (1975), incorporated by reference herein. In some embodiments, the surfactant mixture comprises about 40 to about 99.5 percent by weight of an ionic copolymerizable surfactant and about 0.5 to about 60 percent by weight of a non-copolymerizable surfactant, based upon the total weight of the surfactant mixture.

Typically, the emulsion polymerization of this invention is carried out in the presence of anionic surfactant(s). A useful range of emulsifier concentration is from about 0.5 to about 8 weight percent, preferably from about 1 to about 5 weight percent, based on the total weight of all monomers of the emulsion pressure-sensitive adhesive.

The emulsion pressure-sensitive adhesives of the invention may also contain one or more conventional additives. Preferred additives include tackifiers, plasticizers, dyes, antioxidants, and UV stabilizers. Such additives can be used if they do not affect the superior properties of the emulsion pressure-sensitive adhesives.

If tackifiers are used, then up to about 40% by weight, preferably less than 30% by weight, and more preferably less than 5% by weight based on the dry weight of the total adhesive polymer and nanocrystalline cellulose, would be suitable. In some embodiments, 25 to about 60 parts per hundred parts based on dry weight of the total adhesive component would also be suitable. Suitable tackifiers for use with (meth)acrylate polymer dispersions include rosin acids, rosin esters, terpene phenolic resins, hydrocarbon resins, and cumarone indene resins. The type and amount of tackifier can affect properties such as bonding range, bond strength, heat resistance and specific adhesion. The tackifier will generally be used in the form of an aqueous dispersion. Commercially available tackifiers that are suitable include TACOLYN 1070, 5001 and 5002 (aqueous, 55% solids synthetic resin dispersions based on low molecular weight thermoplastic resins, available from Hercules Inc.), SE1055 (an aqueous dispersion of a rosin ester, available from Hercules Inc.), ESCOREZ 9271 (an aliphatic hydrocarbon resin emulsion, available from Exxon), DERMULSENE 82, DERMULSENE 92, DERMULSENE DT or DERMULSENE DT50 (aqueous dispersions of modified terpene phenolic resins, available from DRT) and AQUATAK 4188 (a modified rosin ester, available from Arizona Chemical Company).

The (meth)acrylate copolymer may be prepared by an emulsion polymerization process. In emulsion polymerization a reaction occurs in micelles or emulsion microdrops suspended in aqueous medium. Any heat generated in the microdrops or micelles is quickly moderated by the effect of the heat capacity of the surrounding water phase. Emulsion polymerization proceeds with better control of exothermic reactions, and the resulting adhesive composition is non-flammable as the aqueous medium is the dominant component.

The pressure-sensitive adhesives of the present invention are prepared by a batch, continuous or semi-continuous emulsion polymerization process. The polymerization generally comprises the steps of:

(a) making a monomer premix comprising

(i) an acrylic acid ester,

(ii) optionally an acid functional monomer;

(iii) optionally a polar monomer,

(iv) optionally a vinyl monomer,

(v) optionally a crosslinking agent,

(vi) optionally a chain transfer agent,

(b) combining said premix with a water phase comprising

(i) water,

(ii) a surfactant selected from the group consisting of anionic surfactants, nonionic surfactants, cationic surfactants, amphoteric surfactants, polymeric surfactants, and mixtures thereof,

(iii) a water soluble free radical initiator,

(c) concurrently agitating and heating said emulsion to a temperature of about 30° C. to about 80° C., and permitting polymerization of said monomers in the oil-in-water emulsion until a polymeric latex is formed. It will be understood that other mixtures may be used. For example, the acid functional monomer, or other hydrophilic monomers, may be added to the aqueous solution. In addition, once the emulsion mixture is prepared, the monomers may partition between the oil phase and the water phase, according to their respective partition coefficients.

In the semi-continuous process, a flask is charged with a seed monomer mixture comprising deionized (DI) water, surfactant, acid functional monomers, acrylate ester monomers, optional co-polymerizable monomers, including optional polar monomers, plus any optional chain transfer agents, pH modifiers or other additives. The mixture is stirred and heated under an inert atmosphere such as a nitrogen blanket. When the mixture has reached induction temperature, typically about 50 to about 70° C., the first initiator is added to initiate the polymerization and the reaction is allowed to exotherm. After the seed reaction is completed, the batch temperature is then raised to the feed reaction temperature, about 70 to about 85° C. At the feed reaction temperature, the monomer pre-emulsion comprising DI water, surfactant acid functional monomers, acrylate ester monomers, optional co-polymerizable monomers, including optional polar monomers, chain transfer agents or other additives is added to the stirred flask over a period of time, typically 2 to 4 hours, while the temperature is maintained. At the end of the feed reaction, the second initiator charge, if used, is added to the reaction to further reduce residual monomers in the emulsion. After an additional hour of heating, the mixture is cooled to room temperature (about 23° C.) and the emulsion is collected for evaluation.

A neutralizing agent may be employed in the preparation of this polymer. It may be employed at a level sufficient to neutralize all or a part of the acid groups of the polymer. Generally, less than 50% of acid groups are neutralized. Neutralization is achieved via the use of an alkali metal hydroxide or a combination of an alkali metal hydroxide with a minor amount of another neutralizing agent. A wide variety of other neutralizing agents may be used as will be understood by those skilled in the art. The selection of the other neutralizing agent, and the amount employed may be varied to achieve a desired result. However, the type and amount selected must not render the adhesive non-dispersible. Usually ammonium, sodium and potassium hydroxide are used as neutralizing agents.

The pH of the emulsion is optionally about 2-6. The acidity of the emulsion may be modified following latex formation using a pH modifier such as a basic solution (e.g., solutions of sodium hydroxide, ammonium hydroxide, lithium hydroxide and the like) or buffer solutions (e.g., sodium bicarbonate and the like), to less acidic levels. Typically, the pH is 7 or less, such as is in the range of 2 to 6, or between 3 and 6.

In order to increase cohesive strength of the poly(meth)acrylate pressure-sensitive adhesives, a crosslinking additive may be added to the latex PSAs. Two main types of crosslinking additives are exemplary. The first crosslinking additive is a thermal crosslinking additive such as multifunctional aziridine, isocyanate and epoxy. One example of aziridine crosslinker is 1,1′-(1,3-phenylene dicarbonyl)-bis-(2-methylaziridine) (CAS No. 7652-64-4). Such chemical crosslinkers can be added into emulsion PSAs after polymerization and activated by heat during oven drying of the coated adhesive.

In another embodiment, chemical crosslinkers, which rely upon free radicals to carry out the crosslinking reaction, may be employed. Reagents such as, for example, peroxides serve as a source of free radicals. When heated sufficiently, these precursors will generate free radicals that bring about a crosslinking reaction of the polymer. A common free radical generating reagent is benzoyl peroxide. Free radical generators are required only in small quantities, but generally require higher temperatures to complete a crosslinking reaction than those required for the bisamide and isocyanate reagents.

The second type of crosslinking additive is a photosensitive crosslinker, which is activated by high intensity ultraviolet (UV) light. Two common photosensitive crosslinkers used for acrylic PSAs are benzophenone and copolymerizable aromatic ketone monomers as described in U.S. Pat. No. 4,737,559 (Kellen et al.) Another photocrosslinker, which can be post-added to the solution polymer and activated by UV light is a triazine, for example, 2,4-bis(trichloromethyl)-6-(4-methoxy-phenyl)-s-triazine. These crosslinkers are activated by UV light generated from sources such as medium pressure mercury lamps or a UV blacklight.

Crosslinking may also be achieved using high energy electromagnetic radiation such as gamma or e-beam radiation. In this case, no crosslinker may be required.

The nanocrystalline cellulose may be incorporated into the acrylate adhesive by adding the nanocrystalline cellulose to an emulsion of the acrylate adhesive. It is preferred that the nanocrystalline cellulose be blended under conditions of low shear to avoid precipitation of the acrylate emulsion. The evaporation step can be accomplished for example, via distillation, rotary evaporation or oven drying. Prior to drying, the emulsion generally does not exhibit pressure-sensitive adhesive properties, so drying to less than 5 wt. % water, preferably less than 1 wt. % water, most preferably less than 0.5 wt. % is desirable. It will be understood that the water content of the adhesive may increase with time, as result of humidity.

Once dispersed in the acrylate adhesive, the nanocrystalline cellulose particles are in a substantially discrete (individual) and unassociated (i.e. non-agglomerated, non-aggregated) condition. “Agglomerated” as used herein, is descriptive of a weak association of particles usually held together by charge or polarity and can be broken down into smaller entities. “Aggregated”, as used herein, is descriptive of a strong association of particles often bound together by, for example, residual chemical treatment; further breakdown of the aggregates into smaller entities is very difficult to achieve.

An advantage of employing nanocrystalline cellulose is that it has been found that the viscosity of the composition only minimally increases over time, unlike when inorganic metal oxide nanoparticles are instead employed. Accordingly, it is not necessary to coat the adhesive composition very soon after preparation in order to avoid a significant viscosity increase.

The emulsion (containing the adhesive polymer and nanocrystalline cellulose) are easily coated upon suitable flexible backing materials by conventional coating techniques to produce adhesive coated sheet materials. The flexible backing material may be any material conventionally utilized as a tape backing, optical film or any other flexible material. Typical examples of flexible backing materials employed as conventional tape backing that may be useful for the adhesive compositions include those made of paper, plastic films such as polypropylene, polyethylene, polyurethane, polyvinyl chloride, polyester (e.g., polyethylene terephthalate), cellulose acetate, polylactic acid, and ethyl cellulose.

Backings may also be prepared of fabric such as woven fabric formed of threads of synthetic or natural materials such as cotton, nylon, rayon, glass, ceramic materials, and the like or nonwoven fabric such as air laid webs of natural or synthetic fibers or blends of these. The backing may also be formed of metal, metallized polymer films, or ceramic sheet materials may take the form of any article conventionally known to be utilized with pressure-sensitive adhesive compositions such as labels, tapes, signs, covers, marking indicia, and the like.

The above-described compositions are coated on a substrate using conventional coating techniques modified as appropriate to the particular substrate. For example, these compositions can be applied to a variety of solid substrates by methods such as roller coating, flow coating, dip coating, spin coating, spray coating knife coating, and die coating. These various methods of coating allow the compositions to be placed on the substrate at variable thicknesses thus allowing a wider range of use of the compositions. Coating thicknesses may vary, but coating thicknesses of 2-50 microns (dry thickness), preferably about 25 microns, are contemplated. The emulsions (containing the adhesive polymer, nanocrystalline cellulose and water) may be of any desirable concentration for subsequent coating, but is typically between 30 to 70 wt. % water, and more typically between 50 and 65 wt. % water. The desired concentration may be achieved by further dilution of the emulsion, or by partial drying.

While the adhesives of the present invention may be suited for use in wet lamination applications, the adhesives may also perform well in dry lamination applications, wherein the resultant lamination is subjected to high heat and humidity conditions.

To begin, pressure-sensitive adhesive is coated onto backings with the desired coating thickness and then dried before lamination. Then, water is sprayed onto glass or other substrate, sometimes along with a small amount of surfactant to lower the water's surface tension, to obtain a thin water layer on the substrate surface. The film is then positioned properly on the substrate, and most of the excess of water is squeezed out to yield a substrate/PSA/film laminate. The remaining water in the laminate will be evaporated in a few days, depending on the materials used in the laminate.

For dry lamination, a PSA is coated onto films (backings) with the desired coating thickness, and then dried before lamination. Such PSA coated film is then adhered onto substrate surface with pressure and/or high temperature to bond the film onto the substrate surface.

In addition to the decorative, light management and optical applications described above, the pressure-sensitive adhesives can be used in a variety of traditional pressure-sensitive adhesive articles, such as tapes, labels, decals, transfer tapes and other articles. For instance, emulsion polymers have been employed for masking tapes, packaging tapes, transfer tapes, foam tapes, medical tapes, and microstructured tapes.

Suitable materials useful as the flexible support or backing for the adhesive articles of the invention include, but are not limited to, foam, paper, latex saturated paper, polymeric film, cellulose acetate film, ethyl cellulose film, cloth (i.e., woven or nonwoven sheeting formed of synthetic or natural materials), metallic foil, and ceramic sheeting.

Examples of materials that can be included in the flexible support include polyolefins such as polyethylene, polypropylene (including isotactic polypropylene), polystyrene, polyester, polyvinyl alcohol, poly(ethylene terephthalate), poly(butylene terephthalate), poly(caprolactam), poly(vinylidene fluoride), and the like. Commercially available backing materials useful in the invention include kraft paper (available from Monadnock Paper, Inc.); cellophane (available from Flexel Corp.); spun-bond poly(ethylene) and poly(propylene), such as TYVEK and TYPAR (available from DuPont, Inc.); and porous films obtained from poly(ethylene) and poly(propylene), such as TESLIN (available from PPG Industries, Inc.), and CELLGUARD (available from Hoechst-Celanese).

Additional examples of materials that can be included as the flexible support include foams, for instance foamed polymer films. Suitable foamed polymer films include polyolefin-based foamed films, such as the polyolefin foams VOLTEXTRA and VOLARA produced by Voltek Division of Sekisui America Corporation (Secaucus, N.J.). The foam may be formed as a coextruded sheet with the adhesive on one or both sides of the foam, or the adhesive may be laminated to it. When the adhesive is laminated to a foam, it may be desirable to treat the surface to improve the adhesion of the adhesive to the foam or to any of the other types of backings. Such treatments are typically selected based on the nature of the materials of the adhesive and of the foam or backing and include primers and surface modifications (e.g., corona treatment, surface abrasion). Additional suitable tape constructions include those described in U.S. Pat. No. 5,602,221 (Bennett et al.).

The flexible support may also comprise a release-coated substrate, such as a release liner. Such substrates are typically employed when an adhesive transfer tape is provided. Examples of release-coated substrates are well known in the art. They include, by way of example, silicone-coated kraft paper and the like. Tapes of the invention may also incorporate a low adhesion backsize (LAB). Typically this LAB is applied to the tape backing surface that is opposite that bearing the pressure-sensitive adhesive. LABs are known in the art.

Various items are described that are pressure-sensitive adhesives, articles, or emulsions.

Embodiment 1 is a pressure-sensitive adhesive including (a) a polymer comprising (i) 80 to 97 parts by weight of monomer units of an (meth)acrylic acid ester of non-tertiary alcohol, the alcohol having from 1 to 20 carbon atoms; (ii) 0 to 10 parts by weight of monomer units of an acid functional monomer; (iii) 0 to 20 parts by weight of monomer units of a second polar monomer; (iv) 0 to 5 parts by weight vinyl monomer units; and (v) 0 to 1 parts by weight crosslinking agent. The pressure-sensitive adhesive further includes (b) 0.5 to 15 parts by weight of nanocrystalline cellulose.

Embodiment 2 is the pressure-sensitive adhesive of embodiment 1 wherein the nanocrystalline cellulose comprises crystallites having cross-sections ranging from 5 nanometers (nm) to 30 nm and lengths ranging from 100 nm to 300 nm.

Embodiment 3 is the pressure-sensitive adhesive of embodiment 1 or embodiment 2 wherein the nanocrystalline cellulose is not surface modified.

Embodiment 4 is the pressure-sensitive adhesive of any of embodiments 1 to 3 comprising 0.5 to 10 parts by weight of nanocrystalline cellulose.

Embodiment 5 is the pressure-sensitive adhesive of any of embodiments 1 to 4 wherein the acid functional group of the acid functional monomer is partially neutralized in the polymer.

Embodiment 6 is the pressure-sensitive adhesive of any of embodiments 1 to 5 wherein the second polar monomer is selected from 2-hydroxyethyl (meth)acrylate; N-vinylcaprolactam; acrylamide; t-butyl acrylamide; dimethylamino ethyl acrylamide; N-octyl acrylamide; poly(alkoxyalkyl) acrylates; poly(vinyl methyl ether); and mixtures thereof.

Embodiment 7 is the pressure-sensitive adhesive of any of embodiments 1 to 6 wherein the polymer comprises 1 to 5 parts by weight of an acid functional monomer and 1 to 5 parts by weight of a second polar monomer.

Embodiment 8 is the pressure-sensitive adhesive of any of embodiments 1 to 7 wherein the polymer is prepared as an aqueous emulsion polymer.

Embodiment 9 is the pressure-sensitive adhesive of any of embodiments 1 to 8 wherein the acid functional monomer is selected from acrylic acid, methacrylic acid, itaconic acid, fumaric acid, crotonic acid, citraconic acid, maleic acid, oleic acid, P-carboxyethyl acrylate, 2-sulfoethyl methacrylate, styrene sulfonic acid, 2-acrylamido-2-methylpropane sulfonic acid, vinyl phosphonic acid, and mixtures thereof.

Embodiment 10 is the pressure-sensitive adhesive of any of embodiments 1 to 9 comprising 1 to 5 parts of a vinyl monomer selected from vinyl esters; styrene, substituted styrene, vinyl halide, vinyl propionate, and mixtures thereof.

Embodiment 11 is the pressure-sensitive adhesive of any of embodiments 1 to 10 wherein the polymer is prepared by emulsion polymerization.

Embodiment 12 is the pressure-sensitive adhesive of any of embodiments 1 to 11 wherein the polymer is crosslinked.

Embodiment 13 is the pressure-sensitive adhesive of any of embodiments 1 to 12 wherein the average number of carbon atoms of the non-tertiary alcohol is from about 4 to about 12.

Embodiment 14 is an adhesive coated sheet material comprising the pressure-sensitive adhesive of any of embodiments 1 to 13.

Embodiment 15 is an article including (a) a substrate; and (b) a first layer of the pressure-sensitive adhesive of any of embodiments 1 to 13 positioned adjacent to a first surface of the substrate.

Embodiment 16 is the article of embodiment 15, wherein the substrate is a foam or a film.

Embodiment 17 the article of embodiment 15 or 16, wherein the substrate is a release liner.

Embodiment 18 is an emulsion including (a) 30 to about 70 weight percent, based on the total weight of the emulsion, of a polymer phase comprising the reaction product of (i) 80 to 95 parts by weight of an (meth)acrylic acid ester of non-tertiary alcohol, the alcohol having from 1 to 20 carbon atoms, with the average number of carbon atoms being from about 4 to about 12; (ii) 0 to 10 parts by weight of an acid functional monomer; (iii) 0 to 20 parts by weight of a second, non-acid functional, polar monomer; (iv) 0 to 5 parts by weight of vinyl monomer; (v) optionally 0.01 to 1 parts by weight of a crosslinking agent; (vi) 0 to 0.5 parts by weight of a chain transfer agent; and (vii) 0.5 to 15 parts by weight of nanocrystalline cellulose, based on 100 parts of polymer, wherein the sum of (i) through (vii) is 100 parts by weight. The emulsion further includes (b) 30 to 70 weight percent of an aqueous phase comprising a surfactant, based on the total weight of the emulsion.

Embodiment 19 is the emulsion of embodiment 18 wherein the emulsion has a pH of 3 to 6.

Embodiment 20 is the emulsion of embodiment 18 or embodiment 19 wherein the nanocrystalline cellulose is not surface modified.

Embodiment 21 is the emulsion of any of embodiments 18 to 20 comprising 0.5 to 10 parts by weight of nanocrystalline cellulose, based on 100 parts of polymer.

Embodiment 22 is the emulsion of any of embodiments 18 to 21 wherein the nanocrystalline cellulose comprises crystallites having cross-sections ranging from 5 nm to 30 nm and lengths ranging from 100 nm to 300 nm.

This invention is further illustrated by the following examples that are not intended to limit the scope of the invention. In the examples, all parts, ratios and percentages are by weight unless otherwise indicated. The following test methods were used to evaluate and characterize the emulsion PSAs produced in the examples. All materials are commercially available, for example from Aldrich Chemicals, unless otherwise indicated or described.

### EXAMPLES

Objects and advantages of this invention are further illustrated by the following examples, but the particular materials and amounts thereof recited in these examples, as well as other conditions and details, should not be construed to unduly limit this invention. These examples are for illustrative purposes only and are not meant to be limiting on the scope of the appended claims.

### Materials

Unless otherwise noted, all parts, percentages, ratios, etc., in the examples and in the remainder of the specification are by weight. Unless otherwise noted, all chemicals are available from chemical suppliers such as Sigma-Aldrich Chemical Company, St. Louis, Mo.

TABLE 1
Glossary of materials.

| Material | Source |
|---|---|
| NanoCrystalline Cellulose (NCC) | Available from the University of Maine (Orono, ME, USA) |
| | (made by the U.S. Forest Service Forest Product |
| | Laboratory (Madison, WI)) |
| FASTBOND 49 emulsion adhesive | Available from 3M Company (St. Paul, MN, USA) |
| (FB49) | |
| ROBOND PS-90 Emulsion (PS-90) | Available from The Dow Chemical Company (Midland, |
| | MI, USA) |
| ROBOND PS-2000 Emulsion (PS- | Available from The Dow Chemical Company (Midland, |
| 2000) | MI, USA) |
| ACRONAL NX2160 (NX2160) | Available from BASF Corporation (Florham Park, NJ, |
| | USA) |
| HOSTAPHAN 3SAB PRIMED | Available from Mitsubishi Polyester Films, Inc. (Greer, SC, |
| POLYETHYLENE | USA) |
| TEREPHTHALATE FILM (PET) | |
| BA (Butyl Acrylate) monomer | Available from BASF (Ludwigshafen, Germany) |
| EHA (2-Ethyl Hexyl Acrylate) | Available from The Dow Chemical Company (Midland, |
| monomer | MI, USA) |
| AA (Acrylic Acid) monomer | Available from The Dow Chemical Company (Midland, |
| | MI, USA) |
| Sodium Polyoxyethylene Alkylether | Available from Montello Inc. (Tulsa, Oklahoma, USA) |
| Sulfuric Ester surfactant | |
| t-Dodecyl Mercaptan chain transfer | Available from Sigma Aldrich (St. Louis, Missouri, USA) |
| agent | |
| APS (Ammonium Persulfate) initiator | Available from Alfa Aesar (Ward Hill, Massachusetts, |
| | USA) |
| NH₄OH (Ammonium Hydroxide) base | Available from Avantor Performance Materials (Center |
| | Valley, PA, USA) |

### Test Method 1: Weight Percent Solids

Aluminum pans were weighed and the weights (W1) were recorded. NCC dispersion and emulsion adhesives were poured into the pans, and the samples (pan and sample) were reweighed. The weights (W2) were again recorded. Samples were then placed in an oven at 120° C. for 2 hours. Samples were removed from the oven and allowed to cool. Subsequently, samples were reweighed and the weights (W3) were recorded. Weight percent solid=100(W2−W1)/(W3−W1). These values were used to calculate the total amount of NCC in final PSA formulations after drying.

### Test Method 2: Shear Strength Test on Stainless Steel

The adhesive films described were cut into strips 0.5 inch (1.27 cm) in width and adhered by their adhesive to flat, rigid stainless steel plates with 1 inch (2.54 cm) length of each adhesive film strip in contact with the plate to which it was adhered. A weight of 2 kilograms (4.5 pounds) was rolled over the adhered portion. Each of the resulting plates with the adhered film strip was equilibrated at room temperature for 15 minutes. Afterwards, the sample plates were hung at room temperature (RT) and a 1 kg weight was hung from the free end of the adhered film strip with the panel tilted 2° from the vertical to insure against any peeling forces. The time (in minutes) at which the weight fell, as a result of the adhesive film strip releasing from the plate, was recorded. The test was discontinued at 10,000 minutes if there was no failure. In the Tables, this is designated as 10,000+ minutes. Three specimens of each tape (adhesive film strip) were tested and the shear strength test times were averaged to obtain the reported shear holding power time values.

### Test Method 3: Shear Strength Test on Fiberboard

Fiberboard was adhered to stainless steel plates using double coated tape and being careful to only touch the edges of the fiberboard. The adhesive films described were cut into strips 1.0 inch (2.54 cm) in width and adhered by their adhesive to the surface of the fiberboard on the stainless steel plates with 1 inch (2.54 cm) length of each adhesive film strip in contact with the plate to which it was adhered. A weight of 2 kilograms (4.5 pounds) was rolled over the adhered portion. Each of the resulting plates with the adhered film strip was equilibrated at room temperature for 15 minutes. Afterwards, the sample plates were hung at room temperature (RT) and a 1 kg weight was hung from the free end of the adhered film strip with the panel tilted 2° from the vertical to insure against any peeling forces. The time (in minutes) at which the weight fell, as a result of the adhesive film strip releasing from the plate, was recorded. The test was discontinued at 10,000 minutes if there was no failure. In the Tables, this is designated as 10,000+ minutes. Three specimens of each tape (adhesive film strip) were tested and the shear strength test times were averaged to obtain the reported shear holding power time values.

### Test Method 4: Peel Adhesion Test on Stainless Steel

Peel adhesion was the force required to remove an adhesive-coated test specimen from a test panel measured at a specific angle and rate of removal. In the Examples, this force was expressed in ounces per inch width of coated sheet. The following procedure was used:

(1) A test specimen 0.5 inch (˜1.3 cm) wide was applied to a horizontally positioned clean stainless steel (SS) test plate. A 2.2 kg rubber roller was used to press a 4 inch (˜10.2 cm) length of specimen into firm contact with the glass surface.

(2) The free end of the specimen was doubled back, nearly touching itself, so the angle of removal was 180°. The free end was attached to the adhesion tester scale.

(3) The stainless steel (SS) test plate was clamped in the jaws of a tensile testing machine which was capable of moving the plate away from the scale at a constant rate of 12 inches (˜30.5 cm) per minute.

(4) The scale reading in ounces was recorded as the tape was peeled from the glass surface. The resulting peel adhesion was converted from ounces/0.5 inch to Newtons/decimeter (N/dm) to yield the peel adhesion values listed. In some instances, the PSA remained on the steel plate while the backing was pulled off the PSA, and in those cases the type of failure was recorded as 2-bond failure, and no peel adhesion values were reported.

### Test Method 5: Caliper Measurement of Dry PSA

Caliper of the final PSA samples was measured using an Absolute Digimatic Indicator (ID-F Series Model 543-558A, Mitutoyo American Corporation, Aurora, Ill., USA) equipped with a 8 millimeter flat tip. The PET film (tape backing) was placed in the indicator and then it was zeroed. A caliper measurement was made in three different locations on each PSA. These values were averaged and converted from mils to micrometers (μm) to obtain the values reported in Table 4.

### Test Method 6: Brookfield Viscosity Measurement

Viscosity of select emulsion adhesives with and without NCC was measured before coating and drying. Solutions of the emulsion adhesives and NCC were rolled overnight to ensure thorough mixing and solutions were left to stand over 2 weeks. Viscosity of each sample was measured on a Model LVDV-II+ viscometer from Brookfield Engineering Laboratories, Inc. (Middleboro, Mass., USA) at 30 RPM using a S63 spindle at the initial time point (after rolling), and at 1 and 2 week intervals. Viscosities were recorded in cP as shown in Table 5.

### Preparatory Example 1. Synthesis of Emulsion Adhesive 1 (EA1)

398 g butyl acrylate (BA), 274 g ethyl hexyl acrylate (EHA), 13 g acrylic acid (AA) and 0.069 g t-dodecyl mercaptan were mixed together to form an oil phase; 275 g water and 12 g sodium polyoxyethylene alkylether sulfuric ester were mixed together to form an aqueous phase. The two phases were blended together to produce a pre-emulsion.

935 g deionized water was charged into a 2-liter resin flask equipped with a thermometer, mechanical agitation with glass retreat blade impeller, condenser, and nitrogen inlet tube. The reactants were stirred under nitrogen blanket and heated to 80° C. 1.3 g ammonium persulfate (APS) initiator was added in one portion. Then the pre-emulsion was fed into the reactor with a pump over the period of 3 hours. Another 1.4 g APS was then added in the reactor and the reaction was continued for 1 hour at 80° C. The latex was then cooled to room temperature, filtered with cheese cloth, and adjusted with ammonia to a pH of 5.

TABLE 2
Weight percent solids of Materials.

| Material | Weight % Solids |
|---|---|
| FB49 | 56.0 |
| PS-90 | 53.1 |
| PS-2000 | 56.7 |
| NX2160 | 65.3 |
| EA1 | 56.3 |
| NCC | 7.2 |

### Preparation of Comparative Examples C1-C5

Emulsion adhesive solutions were coated on PET at 5 mil (˜127 micrometers) thickness and then dried in an oven at 70° C. for 30 minutes to generate PSA samples. Adhesive properties were measured according to Test Methods 2 and 4, as well as Test Method 3 in some cases. The calipers of the dry PSAs were measured according to Test Method 5.

### Preparation of Examples 1-11

In a jar, a quantity of emulsion adhesive and a quantity of a NCC dispersion (7.2% solids) according to Table 3 were combined. The jar was then rolled overnight to ensure thorough mixing. Solutions were coated on PET at 5 mil (˜127 micrometers) thickness and then dried in an oven at 70° C. for 30 minutes to generate PSA samples. Adhesive properties were measured according to Test Methods 2 and 4, as well as Test Method 3 in some cases. The calipers of the dry PSAs were measured according to Test Method 5.

TABLE 3
Formulation Parameters of Comparative Examples 1-5 and Examples 1-11.

| | | Emusion | NCC |
|---|---|---|---|
| | Emulsion | Adhesive | Dispersion |
| Example | Adhesive | Wet (g) | (g) |
| C1 | FB49 | N/A | 0 |
| 1 | FB49 | 27.8 | 2.2 |
| 2 | FB49 | 27.8 | 5.5 |
| 3 | FB49 | 27.8 | 11.1 |
| C2 | PS-90 | N/A | 0 |
| 4 | PS-90 | 40.0 | 7.6 |
| 5 | PS-90 | 40.0 | 15.5 |
| C3 | NX2160 | N/A | 0 |
| 6 | NX2160 | 40.0 | 7.4 |
| 7 | NX2160 | 40.0 | 19.1 |
| C4 | PS-2000 | N/A | 0 |
| 8 | PS-2000 | 20.0 | 3.2 |
| 9 | PS-2000 | 20.0 | 8.3 |
| C5 | EA1 | N/A | 0 |
| 10 | EA1 | 15.0 | 2.39 |
| 11 | EA1 | 15.0 | 6.17 |

TABLE 4
Adhesive properties of Final PSAs - Comparative examples 1-5
and Examples 1-11.

| | | Dry | 180° Peel | RT Shear | RT Shear |
|---|---|---|---|---|---|
| | NCC | Caliper | Adhesion to SS | on SS | on FB |
| Example | (wt %) | (μm) | (oz/in, N/dm) | (min) | (min) |
| C1 | 0 | 58.4 | 24.5, 26.8 | 6,025 | N/A |
| 1 | 1.0 | 50.8 | 23.3, 25.5 | 10,000+ | N/A |
| 2 | 2.5 | 50.8 | 25.3, 27.7 | 10,000+ | N/A |
| 3 | 4.9 | 45.7 | 24.4, 26.7 | 10,000+ | N/A |
| C2 | 0 | 38.1 | 31.4, 34.4 | 407 | N/A |
| 4 | 2.5 | 38.1 | 28.9, 31.6 | 711 | N/A |
| 5 | 5.0 | 33.0 | 29.0, 31.7 | 2,189* | N/A |
| C3 | 0 | 50.8 | 2-bond failure | 262 | 1,547 |
| 6 | 2.0 | 38.1 | 44.6, 48.8 | 3,652 | 10,000+ |
| 7 | 5.0 | 35.6 | 32.0, 35.0 | 10,000+ | 10,000+ |
| C4 | 0 | 35.6 | 2-bond failure | 880 | 3205 |
| 8 | 2.0 | 40.6 | 56.2, 61.5 | 973 | 3601 |
| 9 | 5.0 | 35.6 | 57.8, 63.3 | 10,000+ | 10,000+ |
| C5 | 0 | 48.3 | 35.3, 38.6 | 630 | N/A |
| 10 | 2.0 | 40.6 | 44.5, 48.7 | 2,261 | N/A |
| 11 | 5.0 | 38.1 | 41.4, 45.4 | 10,000+ | N/A |

*Only 2 samples were averaged.

TABLE 5
Viscosities of Emulsion Adhesives with and without NCC
before coating and drying.

| | Initial Viscosity | | Viscosity Week 2 |
|---|---|---|---|
| Example | (cP) | Viscosity 1 week (cP) | (cP) |
| C1 | 3535 | 3151 | 2975 |
| 3 | 2687 | 2931 | 2675 |
| C3 | 304 | 324 | 336 |
| 7 | 2300 | 3123 | 2899 |
| C4 | 84 | 88 | 112 |
| 9 | 1700 | 1616 | 1764 |

While the specification has described in detail certain exemplary embodiments, it will be appreciated that those skilled in the art, upon attaining an understanding of the foregoing, may readily conceive of alterations to, variations of, and equivalents to these embodiments. Furthermore, all publications and patents referenced herein are incorporated by reference in their entirety to the same extent as if each individual publication or patent was specifically and individually indicated to be incorporated by reference. Various exemplary embodiments have been described. These and other embodiments are within the scope of the following claims.

1. A pressure-sensitive adhesive comprising:
(a) a polymer comprising:
(i) 80 to 97 parts by weight of monomer units of an (meth)acrylic acid ester of non-tertiary alcohol, the alcohol having from 1 to 20 carbon atoms;
(ii) 0 to 10 parts by weight of monomer units of an acid functional monomer;
(iii) 0 to 20 parts by weight of monomer units of a second polar monomer;
(iv) 0 to 5 parts by weight vinyl monomer units; and
(v) 0 to 1 parts by weight crosslinking agent; and
(b) 0.5 to 15 parts by weight of nanocrystalline cellulose.

2. The pressure-sensitive adhesive of claim 1 wherein the nanocrystalline cellulose comprises crystallites having cross-sections ranging from 5 nanometers (nm) to 30 nm and lengths ranging from 100 nm to 300 nm.

3. The pressure-sensitive adhesive of claim 1 wherein the nanocrystalline cellulose is not surface modified.

4. The pressure-sensitive adhesive of claim 1 wherein the acid functional group of the acid functional monomer is partially neutralized in the polymer.

5. The pressure-sensitive adhesive of claim 1 to wherein the second polar monomer is selected from 2-hydroxyethyl (meth)acrylate; N-vinylcaprolactam; acrylamide; t-butyl acrylamide; dimethylamino ethyl acrylamide; N-octyl acrylamide; poly(alkoxyalkyl) acrylates; poly(vinyl methyl ether); and mixtures thereof.

6. The pressure-sensitive adhesive of claim 1 wherein the polymer comprises 1 to 5 parts by weight of an acid functional monomer and 1 to 5 parts by weight of a second polar monomer.

7. The pressure-sensitive adhesive of claim 1 wherein the polymer is prepared as an aqueous emulsion polymer.

8. The pressure-sensitive adhesive of claim 1 comprising 1 to 5 parts of a vinyl monomer selected from vinyl esters; styrene, substituted styrene, vinyl halide, vinyl propionate, and mixtures thereof.

9. An adhesive coated sheet material comprising the pressure-sensitive adhesive of claim 1.

10. An article comprising:
(a) a substrate; and
(b) a first layer of the pressure-sensitive adhesive of claim 1 positioned adjacent to a first surface of the substrate.

11. The article of claim 10, wherein the substrate is a foam or a film.

12. The article of claim 10, wherein the substrate is a release liner.

13. An emulsion comprising:
(a) 30 to about 70 weight percent, based on the total weight of the emulsion, of a polymer phase comprising the reaction product of:
(i) 80 to 95 parts by weight of an (meth)acrylic acid ester of non-tertiary alcohol, the alcohol having from 1 to 20 carbon atoms, with the average number of carbon atoms being from about 4 to about 12;
(ii) 0 to 10 parts by weight of an acid functional monomer;
(iii) 0 to 20 parts by weight of a second, non-acid functional, polar monomer;
(iv) 0 to 5 parts by weight of vinyl monomer;
(v) optionally 0.01 to 1 parts by weight of a crosslinking agent;
(vi) 0 to 0.5 parts by weight of a chain transfer agent; and
(vii) 0.5 to 15 parts by weight of nanocrystalline cellulose, based on 100 parts of polymer,
wherein the sum of (i) through (vii) is 100 parts by weight, and
(b) 30 to 70 weight percent of an aqueous phase comprising a surfactant, based on the total weight of the emulsion.

14. The emulsion of claim 13 wherein the nanocrystalline cellulose is not surface modified.

15. The emulsion of claim 13 comprising 0.5 to 10 parts by weight of nanocrystalline cellulose, based on 100 parts of polymer.
